(19) United States
(12) Patent Application Publication
(10) Pub. No.: US 2015/0237334 A1
(43) Pub. Date: Aug. 20, 2015

(54) STEREOSCOPIC DISPLAY DEVICE

(71) Applicant: SHARP KABUSHIKI KAISHA, Osaka-shi, Osaka (JP)

(72) Inventors: Takehiro Murao, Osaka (JP); Hiroshi Fukushima, Osaka (JP)

(73) Assignee: Sharp Kabushiki Kaisha, Osaka (JP)

(21) Appl. No.: 14/429,265

(22) PCT Filed: Sep. 24, 2013
(86) PCT No.: PCT/JP2013/075721

§ 371 Date: Mar. 18, 2015

(30) Foreign Application Priority Data
Sep. 27, 2012 (JP) 2012-214539

(51) Int. Cl. H04N 13/04

(52) U.S. Cl. CPC H04N 13/0404; H04N 13/0468

(57) ABSTRACT

Provided is a stereoscopic display device via which a good stereoscopic image can be obtained with little crosstalk across a wide zone. A stereoscopic display device is provided with: a display panel that displays an image; a lens sheet, which is arranged in a superimposed manner on the display panel, and which separates an image displayed on the display panel into a right-eye image and a left-eye image in the horizontal direction; a control unit that controls the display panel; and a position sensor that acquires position information with respect to an observer and supplies the same to the control unit. The display panel includes first pixel rows and second pixel rows arranged alternately in a vertical direction. The control unit, according to the position information, causes either the first pixel rows or the second pixel rows to alternately display pixel data constituting the right-eye image and pixel data constituting the left-eye image in the horizontal direction.

### TECHNICAL FIELD

The present invention relates to an autostereoscopic display device.

### BACKGROUND ART

Two broad categories of stereoscopic display devices capable of being enjoyed with the naked eye are known: parallax barrier systems and lenticular lens systems. These stereoscopic display devices separate light using either a barrier or a lens, and provide an observer with a stereoscopic effect by presenting different images to the right and left eyes. Among the autostereoscopic display devices marketed in recent years, dual-view parallax barrier systems and lenticular lens systems have become the mainstream.

The dual-view stereoscopic display device can produce a good stereoscopic display in a set zone, but when the observer moves his head, there are zones in which there occurs a phenomenon called crosstalk, in which an image to be presented to the right eye and an image to be presented to the left eye intermix and are presented in an overlapping manner, and/or what is called reversed stereo, in which an image to be presented to the right eye is presented to the left eye. Therefore, the observer can only observe a stereoscopic image from a limited zone. In response to this problem, tracking technology, which detects the position of the head of the observer and displays an image in accordance with this position, and/or multi-view technology are being proposed, but a stereoscopic display device that makes it possible to observe a stereoscopic image at a wide range of angles while maintaining dual-view stereoscopic display performance does not exist.

A stereoscopic display device disclosed in Japanese Patent No. 2953433 has a display device, and a parallax image separating method. The display device has first pixel rows in which a plurality of right-eye pixels are lined up side-by-side in a straight line in the horizontal direction at a specific pixel pitch, and second pixel rows in which a plurality of left-eye pixels are lined up side-by-side in a straight line in the horizontal direction at a specific pixel pitch. The first pixel rows and the second pixel rows are lined up side-by-side in an alternating manner in the vertical direction such that the right-eye pixels and the left-eye pixels are offset in the horizontal direction by ½ of the pixel pitch.

### SUMMARY OF THE INVENTION

The problem with the stereoscopic display device disclosed in Japanese Patent No. 2953433 is that the higher the aperture ratio of the pixels, the narrower the zone in which the stereoscopic image is able to be observed.

An object of the present invention is to provide a stereoscopic display device via which a low-crosstalk stereoscopic image that does not lose display quality when displayed two-dimensionally can be obtained across a wide zone.

The stereoscopic display device disclosed herein is provided with: a display panel for displaying an image; a lens sheet superimposed on the display panel and that divides the image displayed on the display panel into a right-eye image and a left-eye image in a horizontal direction; a control unit that controls the display panel; and a position sensor that acquires positional information of an observer and supplies the positional information to the control unit, wherein the display panel includes first pixel rows and second pixel rows alternately arranged in a vertical direction, wherein a position of the right-eye image emitted from the first pixel rows and divided by the lens sheet differs in the horizontal direction from a position of the right-eye image emitted by the second pixel rows and divided by the lens sheet, wherein a position of the left-eye image emitted from the first pixel rows and divided by the lens sheet differs in the horizontal direction from a position of the left-eye image emitted by the second pixel rows and divided by the lens sheet, and wherein the control unit, based on the positional information of the observer, causes pixel data that forms the right-eye image and pixel data that forms the left-eye image to be alternately displayed in the horizontal direction in either the first or second pixel rows.

The present invention provides a stereoscopic display device via which a low-crosstalk stereoscopic image can be obtained across a wide zone.

### BRIEF DESCRIPTION OF THE DRAWINGS

FIG. 1 is a schematic cross-sectional view illustrating the configuration of a stereoscopic display device according to an Embodiment 1 of the present invention.

FIG. 2 is a block diagram illustrating the functional configuration of the stereoscopic display device.

FIG. 3 is an exploded perspective view illustrating the configuration of the lens sheet and the arrangement of the pixels in the display panel in detail.

FIG. 4 is a plan view illustrating the configuration of the pixels in detail.

FIG. 5 is a table summarizing the operation of the stereoscopic display device in respective display modes.

FIG. 6 is a plan view schematically illustrating the display panel mode of display in the three-dimensional display mode.

FIG. 7 is a drawing schematically illustrating light being emitted from the display panel.

FIG. 8 is angular characteristics of luminance in the stereoscopic display device.

FIG. 9 is a drawing illustrating the angular characteristics of left-eye crosstalk XT(L) and right-eye crosstalk XT(R).

FIG. 10 is a drawing for illustrating the effects of a double-arcuated cylindrical lens.

FIG. 11 is a drawing for illustrating the operation in the three-dimensional tracking display mode.

FIG. 12 is a drawing for illustrating the operation in the three-dimensional tracking display mode.

FIG. 13 is a drawing for illustrating the operation in the three-dimensional tracking display mode.

FIG. 14 is a drawing illustrating the angular characteristics of crosstalk in a stereoscopic display device.

FIG. 15 is a drawing illustrating the angular characteristics of stereoscopic display device crosstalk in the three-dimensional tracking display mode.

FIG. 16 is a drawing illustrating the angular characteristics of luminance in the stereoscopic display device.

FIG. 17 is a table showing the characteristics of the stereoscopic display device according to an embodiment of the present invention in comparison to a stereoscopic display device according to other techniques.

FIG. 18 is an exploded perspective view illustrating the detailed configuration of the lens sheet and the arrangement of the pixels in the display panel of a stereoscopic display device according to Embodiment 2 of the present invention.

FIG. 19 is an exploded perspective view illustrating the detailed configuration of the lens sheet and the arrangement of the pixels in the display panel of a stereoscopic display device according to Embodiment 3 of the present invention.

FIG. 20 is a plan view illustrating the detailed configuration of the pixels in the display panel of the stereoscopic display device according to Embodiment 3 of the present invention.

### DETAILED DESCRIPTION OF EMBODIMENTS

A stereoscopic display device according to an embodiment of the present invention is provided with: a display panel for displaying an image; a lens sheet superimposed on the display panel and that divides the image displayed on the display panel into a right-eye image and a left-eye image in a horizontal direction; a control unit that controls the display panel; and a position sensor that acquires positional information of an observer and supplies the positional information to the control unit, wherein the display panel includes first pixel rows and second pixel rows alternately arranged in a vertical direction, wherein a position of the right-eye image emitted from the first pixel rows and divided by the lens sheet differs in the horizontal direction from a position of the right-eye image emitted by the second pixel rows and divided by the lens sheet, wherein a position of the left-eye image emitted from the first pixel rows and divided by the lens sheet differs in the horizontal direction from a position of the left-eye image emitted by the second pixel rows and divided by the lens sheet, and wherein the control unit, based on the positional information of the observer, causes pixel data that forms the right-eye image and pixel data that forms the left-eye image to be alternately displayed in the horizontal direction in either the first or second pixel rows. (First Configuration).

According to the above configuration, the position of a right-eye image emitted from the first pixel rows and separated by the lens sheet differs in the horizontal direction from the position of a right-eye image emitted from the second pixel rows and separated by the lens sheet. In the same manner, the position of a left-eye image emitted from the first pixel rows and separated by the lens sheet differs in the horizontal direction from the position of a left-eye image emitted from the second pixel rows and separated by the lens sheet. The control unit causes an image to be displayed in accordance with the observer position information by selecting either the first pixel rows or the second pixel rows. That is, the control unit selects either the first pixel rows or the second pixel rows such that the position of the right-eye image approaches the right eye of the observer, and the position of the left-eye image approaches the left eye of the observer. This makes it possible for a low-crosstalk stereoscopic image to be obtained across a wide zone.

It is preferable that the first configuration above include a plurality of cylindrical lenses extending in the vertical direction, and that each of the plurality of cylindrical lenses have two lens centers that are separated by a prescribed pitch in the horizontal direction (Second Configuration).

According to the above configuration, light separated by a part of the cylindrical lens having the one lens center and light separated by a part having the other lens center overlap one another. Therefore, high luminance can be obtained at a wider range in each of the right-eye image and the left-eye image, enabling crosstalk to be reduced. In other words, it is possible to widen the low-crosstalk zone.

This makes it possible to respectively widen the low-crosstalk zone of the first pixel rows and the low-crosstalk zone of the second pixel rows. Thus, an even lower crosstalk zone can be achieved while switching between the first pixel rows and the second pixel rows.

In the first or second configuration above, the configuration may be such that the first pixel rows and the second pixel rows include a plurality of pixels aligned at a prescribed pixel pitch in the horizontal direction, and that the pixels in the first pixel rows and the pixels of the second pixel rows are arranged so as to be offset by half of the pixel pitch (Third Configuration).

In the first or second configurations above, the configuration may be such that the lens sheet includes a first lens rows superimposed on the first pixel rows in a plan view, and a second lens rows superimposed on the second pixel rows in the plan view, that the first lens rows and the second lens rows includes a plurality of lenses aligned at a prescribed lens pitch in the horizontal direction, and that the lenses of the first lens rows and the lenses of the second lens rows are arranged so as to be offset by ¼ of the lens pitch in the horizontal direction (Fourth Configuration).

In the first or second configurations above, the configuration may be such that the first pixel rows and the second pixel rows includes a plurality of pixels aligned at a prescribed pixel pitch in the horizontal direction, and that respective light transmissive portions in pixels of the first pixel rows and respective light transmissive portions in pixels of the second pixel rows are arranged so as to be offset by half of the pixel pitch in the horizontal direction (Fifth Configuration).

In any of the first to the fifth configurations above, it is preferable that the control unit have a two-dimensional display mode as a display mode, and in the two-dimensional display mode, the control unit cause an image to be displayed in both the first pixel rows and the second pixel rows regardless of the positional information of the observer, and cause the same image to be displayed in adjacent the first pixel rows and the second pixel rows (Sixth Configuration).

As described above, the positions of a right-eye image and a left-eye image emitted from the first pixel rows and separated by the lens sheet differ in the horizontal direction from the positions of a right-eye image and a left-eye image emitted from the second pixel rows and separated by the lens sheet. Therefore, by causing both the first pixel rows and the second pixel rows to be lit, and, in addition, causing the same image to be displayed in the first pixel rows and the second pixel rows, a flat luminance distribution can be achieved by the overlapping thereof. According to the above configurations, it is possible to obtain a two-dimensional image with no moire effect in the two-dimensional display mode.

In any of the first to the sixth configuration above, the display panel may be a liquid crystal display panel (Seventh Configuration).

### Embodiments

Embodiments of the present invention will be described in detail below by referring to the drawings. In the drawings, the same reference characters are given to the same or equivalent parts, and descriptions thereof will not be repeated. To make the descriptions easier to understand, the configurations may be either simplified or exemplified, and a portion of the components may be omitted in the drawings referenced below. Also, the dimensional relationships between components illustrated in the respective drawings do not necessarily indicate the actual dimensional relationships.

### Embodiment 1

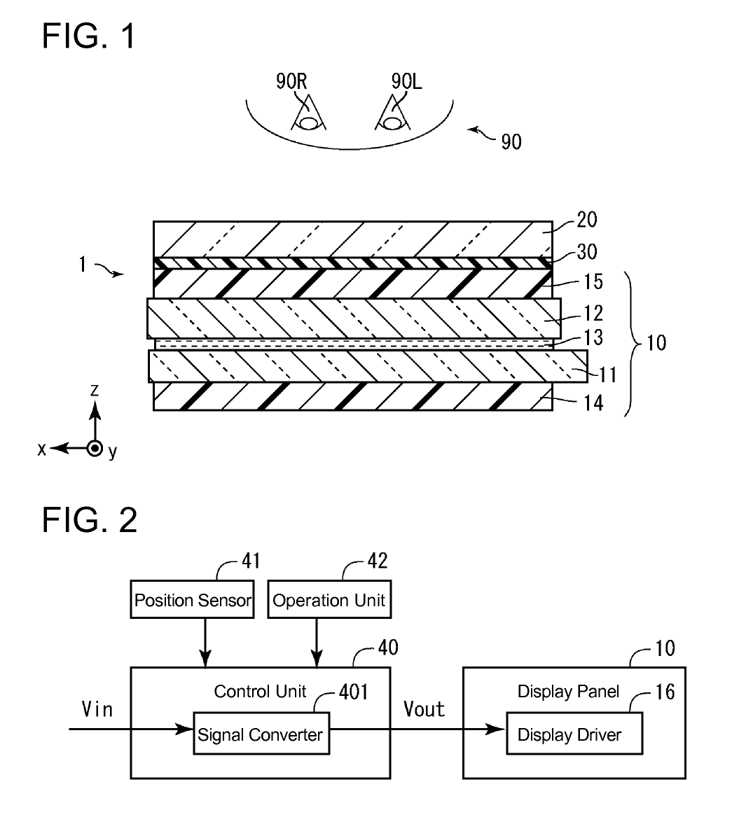

FIG. 1 is a schematic cross-sectional view illustrating the configuration of a stereoscopic display device 1 according to an Embodiment 1 of the present invention. The stereoscopic display device 1 is provided with a display panel 10, a lens sheet 20, and an optical clear adhesive (OCA) 30. The display panel 10 and the lens sheet 20 are arranged in a superimposed manner, and are bonded together using the OCA 30.

The display panel 10 is provided with a thin film transistor (TFT) substrate 11, a color filter (CF) substrate 12, a liquid crystal layer 13, and polarizing plates 14 and 15. The display panel 10 controls the TFT substrate 11 and the CF substrate 12 to manipulate the orientation of liquid crystal molecules in the liquid crystal layer 13. Light from a backlight unit (not shown) is irradiated onto the display panel 10. The display panel 10 displays an image by adjusting the amount of transmitted light for each pixel using the liquid crystal layer 13 and the polarizing plates 14 and 15.

The lens sheet 20 separates an image to be displayed on the display panel 10 into a right-eye image and a left-eye image. The configuration of the lens sheet 20 will be described in detail later.

A direction (x direction in FIG. 1) that is parallel to a line segment connecting the right eye 90R and the left eye 90L of an observer 90 when the observer 90 and the stereoscopic display device 1 are directly facing one another as shown in FIG. 1 is called the horizontal direction below. Furthermore, a direction (y direction in FIG. 1) that is orthogonal to the in-plane horizontal direction of the display panel 10 is called the vertical direction.

FIG. 2 is a block diagram illustrating the functional configuration of the stereoscopic display device 1. The stereoscopic display device 1 is further provided with a control unit 40, a position sensor 41, and an operation unit 42.

The control unit 40 controls the display panel 10, and causes an image to be displayed on the display panel 10. The control unit 40 includes a signal converter 401.

The stereoscopic display device 1 has a plurality of display modes as will be described later. The signal converter 401 converts an input signal Vin in accordance with a display mode, and supplies the converted input signal to a display driver 16 of the display panel 10 as an output signal Vout. The display driver 16 is a gate driver and a source driver, for example.

The position sensor 41 acquires observer 90 position information. The position sensor 41 is an eye tracking system that acquires an image via a camera, and detects the positions of the eyes of the observer 90 via image processing, for example. Alternatively, the position sensor 41 may be a head tracking system that detects the position of the head of the observer 90 using infrared rays. The position sensor 41 supplies the acquired position information to the control unit 40.

The operation unit 42 receives an operation from a user, and supplies the received information to the control unit 40. The user switches the display mode of the stereoscopic display device 1 by manipulating the operation unit 42.

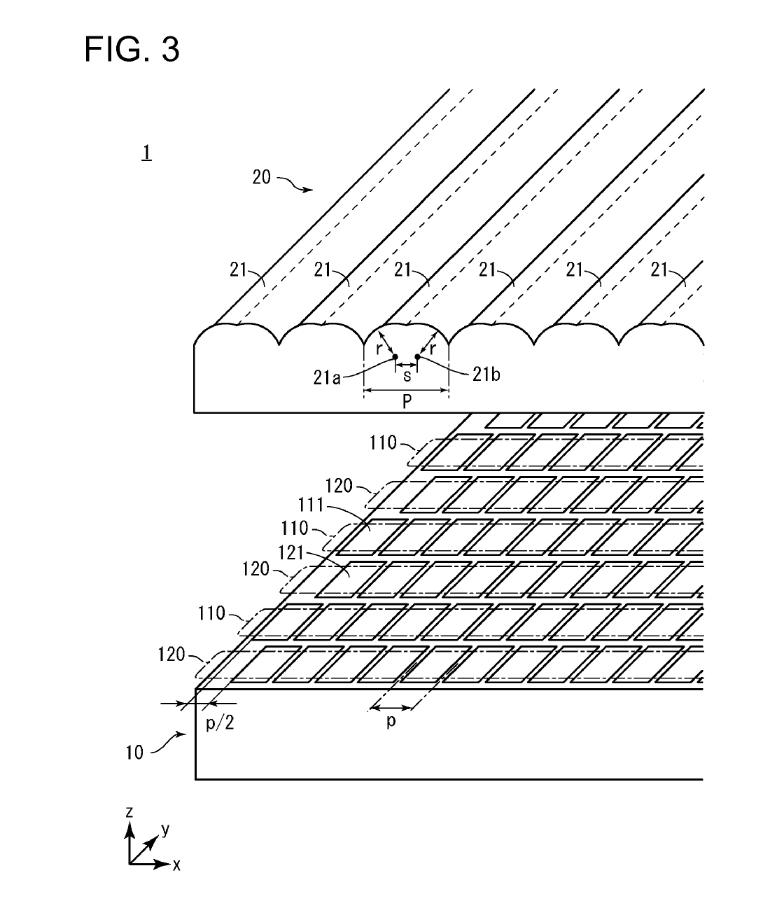

FIG. 3 is an exploded perspective view illustrating the configuration of the lens sheet 20, and the arrangement of the pixels in the display panel 10 in detail.

As illustrated in FIG. 3, the lens sheet 20 includes a plurality of cylindrical lenses 21 extending along the vertical direction. The plurality of cylindrical lenses 21 is aligned at a lens pitch P in the horizontal direction. Each of the plurality of cylindrical lenses 21 is a double-arcuated cylindrical lens having two lens centers 21a and 21b separated by an amount of lens shift s in the horizontal direction. More specifically, each of the plurality of cylindrical lenses 21 has a shape in which two lenses with the same radius of curvature overlap.

The display panel 10 includes U rows (first pixel rows) 110 and B rows (second pixel rows) 120, which are arranged in an alternating manner in the vertical direction. The U rows 110 include a plurality of pixels 111 aligned at the pixel pitch p in the horizontal direction. In the same manner, the B rows 120 include a plurality of pixels 121 aligned at the pixel pitch p in the horizontal direction.

The pixels 111 of the U rows 110 and the pixels 121 of the B rows 120 are arranged so as to be offset by half of the pixel pitch p (p/2) in the horizontal direction. In accordance with this, the position of the light emitted from the U rows 110 and separated by the lens sheet 20 differs in the horizontal direction from the position of the light emitted from the B rows 120 and separated by the lens sheet 20. More specifically, the positions of the right-eye image emitted from the U rows 110 and separated by the lens sheet 20 and the right-eye image emitted from the B rows 120 and separated by the lens sheet 20 differ in the horizontal direction. In the same manner, the positions of the left-eye image emitted from the U rows 110 and separated by the lens sheet 20 and the left-eye image emitted from the B rows 120 and separated by the lens sheet 20 differ in the horizontal direction.

The lens pitch P is approximately two times the pixel pitch p.

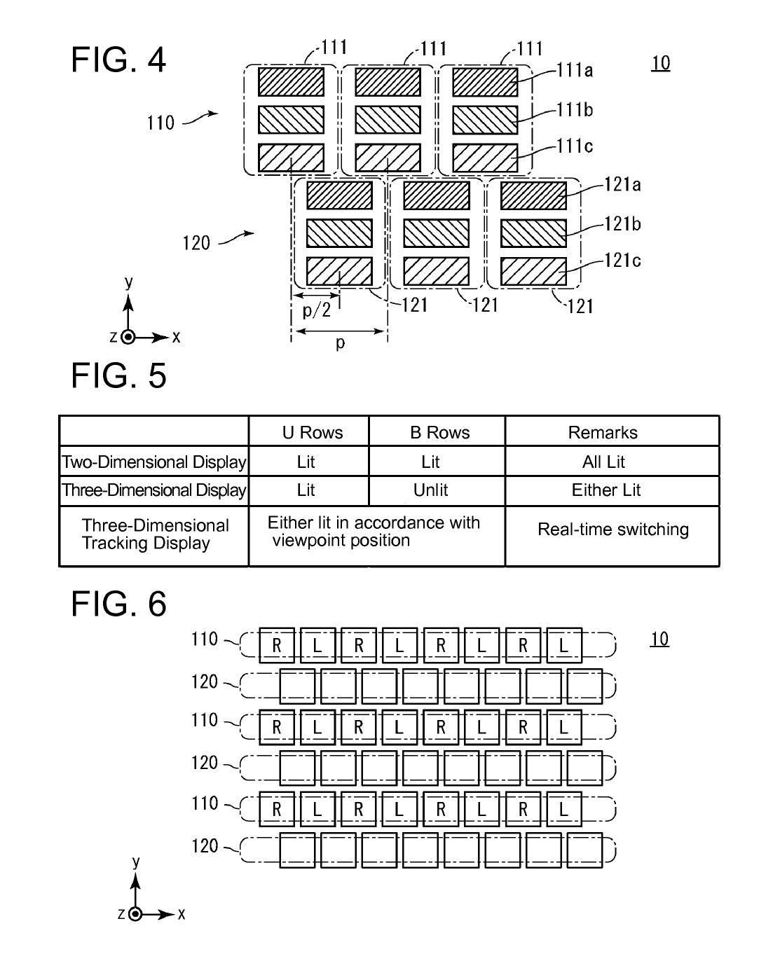

FIG. 4 is a plan view illustrating the configurations of the pixels 111 and 121 in detail. The pixels 111 include sub-pixels 111a, 111b, and 111c, which are aligned in the vertical direction. In the same manner, the pixels 121 also include sub-pixels 121a, 121b, and 121c, which are aligned in the vertical direction. The hatching in FIG. 4 schematically represents the fact that the respective sub-pixels are different colors, and does not indicate a cross-sectional structure.

The sub-pixels 111a and 121b transmit red light, the sub-pixels 111b and 121b transmit green light, and the sub-pixels 111c and 121c transmit blue light, for example. In areas other than these, the light is shielded by a black matrix. In other words, the pixels 111 have light transmissive portions in the sub-pixels 111a, 111b, and 111c, and the pixels 121 have light transmissive portions in the sub-pixels 121a, 121b, and 121c.

The configuration of the stereoscopic display device 1 was described above. Next, the operation of the stereoscopic display device 1 will be described.

FIG. 5 is a table summarizing the operation of the stereoscopic display device 1 in respective display modes. As display modes, the stereoscopic display device 1 has a two-dimensional display mode, a three-dimensional display mode, and a three-dimensional tracking display mode. As shown in FIG. 5, the control unit 40 causes both the U rows 110 and the B rows 120 to be lit in the two-dimensional display mode. In the three-dimensional display mode, the control unit 40 causes either the U rows 110 or the B rows 120 to be lit. Then, in the three-dimensional tracking display mode, the control unit 40 causes either the U rows 110 or the B rows 120 to be lit on the basis of position information supplied from the position sensor 41.

[Three-Dimensional Display Mode]

The control unit 40 causes either one of the U rows 110 or the B rows 120 to be lit in the three-dimensional display mode. FIG. 6 is a plan view schematically illustrating the display panel 10 mode of display in the three-dimensional display mode. In FIG. 6, the control unit 40 causes the U rows 110 to be lit, and sets the B rows 120 to un-lit. The control unit 40 causes pixel data (R) constituting a right-eye image and pixel data (L) constituting a left-eye image to be displayed in an alternating manner in the pixels 111 of the U rows 110.

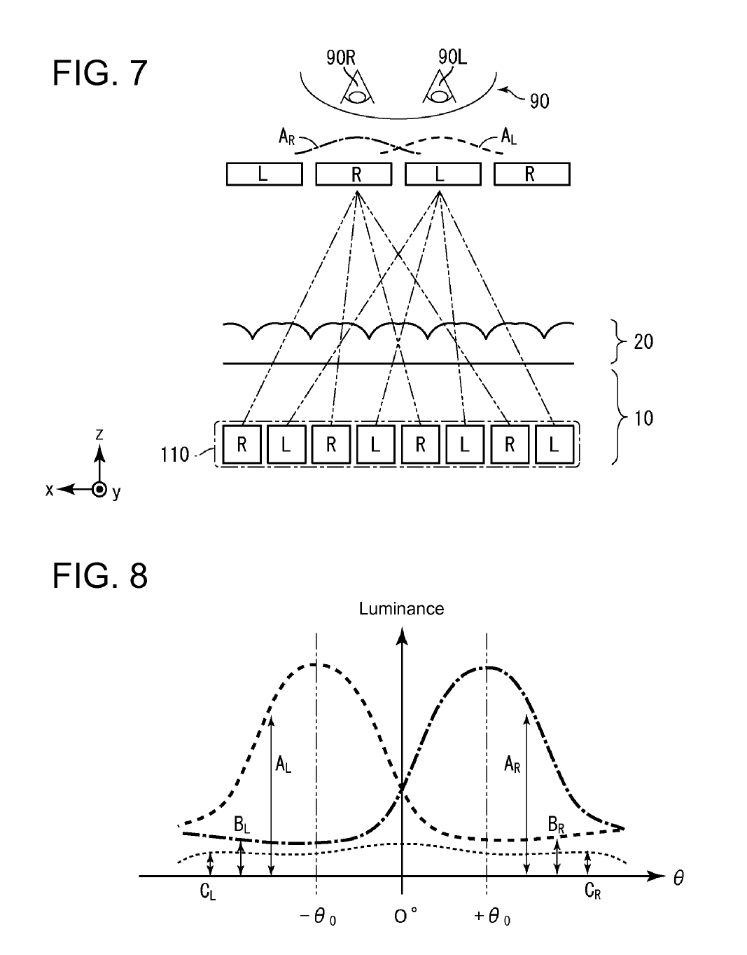

FIG. 7 is a drawing schematically illustrating light that is emitted from the display panel 10. As illustrated in FIG. 7, the image displayed on the display panel 10 is separated in the horizontal direction into a right-eye image and a left-eye image by the lens sheet 20. When the observer 90 observes the stereoscopic display device 1 in the optimum position, the right-eye image is presented to his right eye 90R and the left-eye image is presented to his left eye 90L. In accordance with this, the observer 90 perceives the image being displayed on the display panel 10 as a stereoscopic image.

The distributions of luminance A_{L} in the left-eye image and luminance A_{R} in the right-eye image are schematically illustrated in FIG. 7 by a dashed line and a one-dot chain line, respectively. In FIG. 7, the luminance A_{L} of the left-eye image is the maximum at the left eye 90L position, and the luminance A_{R} of the right-eye image is the maximum at the right eye 90R position.

When the observer 90 moves from this position, the luminance A_{L} of the left-eye image decreases and the luminance A_{R} of the right-eye image increases at the left eye 90L position. In the same manner, the luminance A_{R} of the right-eye image decreases and the luminance A_{L} of the left-eye image increases at the right eye 90R position. The result is that the right-eye image leaks into the left eye 90L, and the left-eye image leaks into the right eye 90R. This phenomenon is called crosstalk, and when significant, not only causes the loss of the stereoscopic effect, but also causes the observer 90 to experience discomfort.

Crosstalk will be defined in a quantitative manner using FIG. 8. FIG. 8 is the angular characteristics of luminance in the stereoscopic display device 1. Luminance A_{L} is the luminance that was measured at an angle θ<0 when the right-eye image was a black display and the left-eye image was a white display. Luminance B_{R} is the luminance that was measured at an angle θ<0 for the same screen. Luminance A_{R} is the luminance that was measured at an angle θ<0 when the right-eye image was a white display and the left-eye image was a black display. Luminance B_{L} is the luminance that was measured at an angle θ<0 for the same screen. Luminance C_{L} is the luminance that was measured at an angle θ<0 when both the right-eye image and the left-eye image were black displays. Luminance C_{R} is the luminance that was measured at an angle θ<0 for the same screen.

The left-eye crosstalk XT(L) at this time is defined in accordance with the following formula.

$$XT ( L ) [ \% ] = \frac{{B}_{L} ( θ ) - {C}_{L} ( θ )}{{A}_{L} ( θ ) - {C}_{L} ( θ )} \times 100 \qquad [ Formula 1 ]$$

In the same manner, right-eye crosstalk XT(R) is defined in accordance with the following formula.

$$XT ( R ) [ \% ] = \frac{{B}_{R} ( θ ) - {C}_{R} ( θ )}{{A}_{R} ( θ ) - {C}_{R} ( θ )} \times 100 \qquad [ Formula 2 ]$$

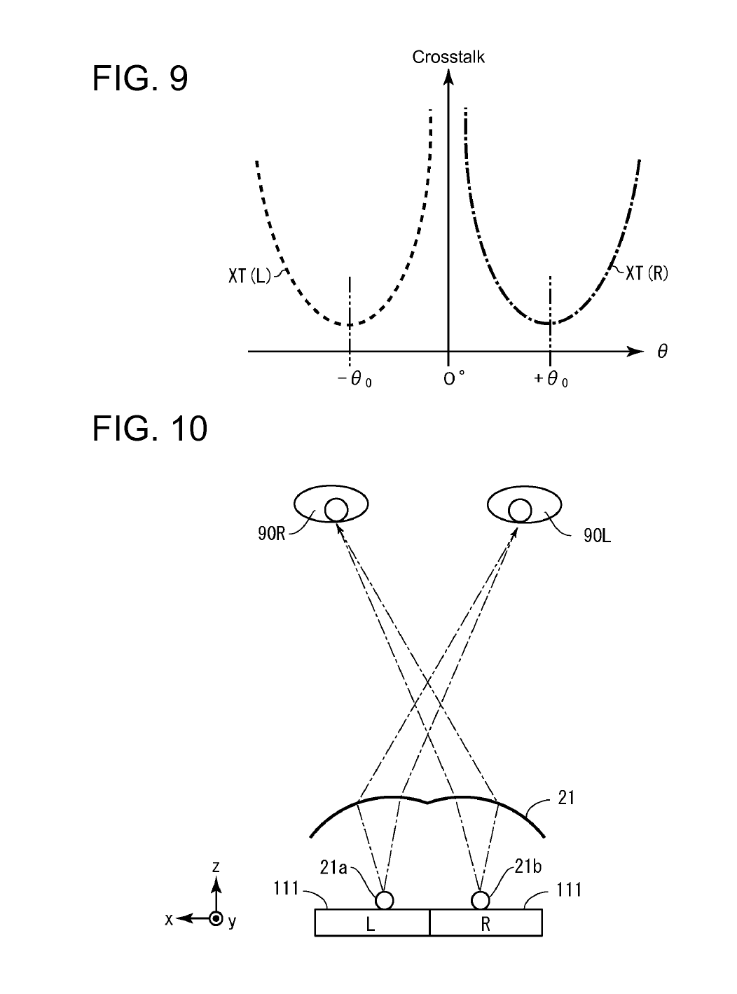

FIG. 9 is a drawing illustrating the angular characteristics of left-eye crosstalk XT(L) and right-eye crosstalk XT(R). Left-eye crosstalk XT(L) takes the minimum value at angle θ₀ and increases as it deviates from angle −θ₀. Right-eye crosstalk XT(R) takes the minimum value at angle +θ₀ and increases as it deviates from angle +θ₀.

FIG. 10 is a drawing for illustrating the effect of the double-arcuated cylindrical lens 21. As previously described, each of a plurality of cylindrical lenses 21 has two lens centers 21a and 21b. According to this configuration, the lens center 21a and the lens center 21b can provide focal points in their respective positions, thereby improving right-left image separation characteristics. This makes it possible to achieve more luminance and to lower crosstalk in both the right-eye image and the left-eye image. In other words, the low-crosstalk zone can be widened.

[Three-Dimensional Tracking Display Mode]

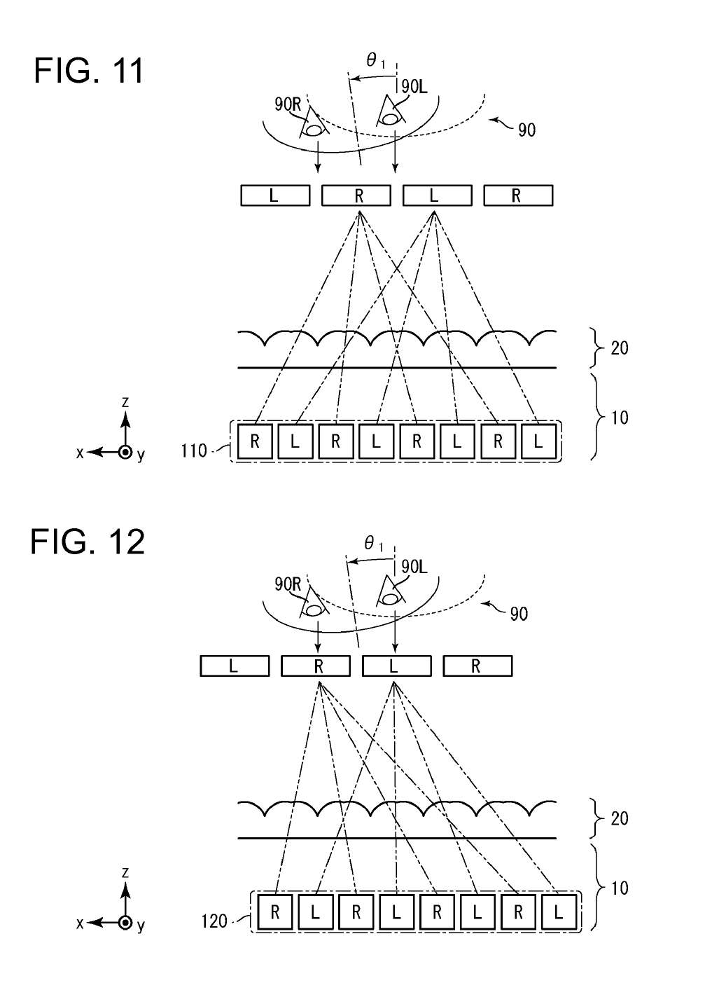

The control unit 40, on the basis of position information supplied from the position sensor 41, causes either the U rows 110 or the B rows 120 to be lit in the three-dimensional tracking display mode. Operation in the three-dimensional tracking display mode will be described below using FIG. 11 to FIG. 13.

FIG. 11 illustrates a state in which the observer 90 moves to a high-crosstalk zone. In FIG. 11, the control unit 40 causes the U rows 110 to be lit, and sets the B rows 120 to un-lit. The control unit 40 causes pixel data constituting the right-eye image and pixel data constituting the left-eye image to be displayed in an alternating manner in the U rows 110.

The control unit 40 reverses the lighting state of the U rows 110 and the B rows 120 when the angle formed by a line segment connecting to the observer 90 from the center of the stereoscopic display device 1 and a normal line of the display panel 10 is a prescribed value θ₁ or larger, for example. That is, the control unit 40 causes the B rows 120 to be lit and sets the U rows 110 to un-lit as illustrated in FIG. 12. At this time, the control unit 40 causes pixel data constituting the right-eye image and pixel data constituting the left-eye image to be displayed in an alternating manner in the B rows 120.

As previously described, the positions of the right-eye image and the left-eye image emitted from the U rows 110 and separated by the lens sheet 20 differ from the positions of the right-eye image and the left-eye image emitted from the B rows 120 and separated by the lens sheet 20. These images, more specifically, are offset by half of the inter-viewpoint distance in the horizontal direction. That is, the center position (the position with the highest luminance) of the right-eye image emitted from the B rows 120 and separated by the lens sheet 20 falls midway between the center position of the right-eye image and the center position of the left-eye image emitted from the U rows 110 and separated by the lens sheet 20. In the same manner, the center position of the left-eye image emitted from the B rows 120 and separated by the lens sheet 20 falls midway between the center position of the right-eye image and the center position of the left-eye image emitted from the U rows 110 and separated by the lens sheet 20.

Thus, the zone in which crosstalk is high when the U rows 110 are lit becomes the zone in which crosstalk is low when the B rows 120 are lit. In accordance with this, in FIG. 12 the observer 90 is in the low-crosstalk zone.

Thus, the control unit 40, in accordance with the position of the observer 90, causes whichever is the low-crosstalk side, i.e. the U rows 110 or the B rows 120, to be lit. This makes it possible to achieve low crosstalk across a wide zone.

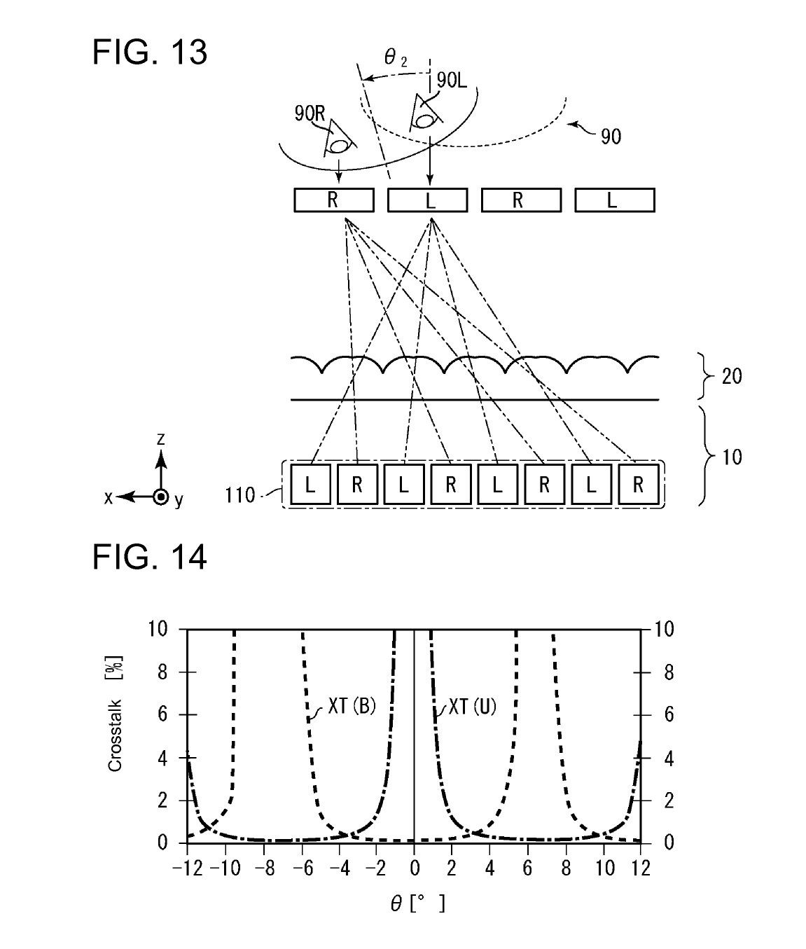

FIG. 13 illustrates a state in which the observer 90 has moved further in the same direction from the state in FIG. 12. The control unit 40 once again reverses the lighting state of the U rows 110 and the B rows 120 when the angle formed by a line segment connecting to the observer 90 from the center of the stereoscopic display device 1 and a normal line of the display panel 10 is a prescribed value θ₂ or larger, for example. That is, the control unit 40 causes the U rows 110 to be lit and sets the B rows 120 to un-lit as illustrated in FIG. 13. At this time, the control unit 40 causes pixel data constituting the right-eye image and pixel data constituting the left-eye image to be displayed in an alternating manner in the U rows 110.

In addition, the control unit 40 reverses the sequence of the pixel data constituting the right-eye image and the pixel data constituting the left-eye image from the state in FIG. 11 (right-left image swap). This makes it possible to avoid reversed stereo (a state in which the left-eye image is presented to the right eye 90R and the right-eye image is presented to the left eye 90L).

When the position of the observer 90 moves in one direction like this, the control unit 40 causes displays to be performed in the sequence U rows 110, B rows 120, U rows 110 (left-right image swap), B rows 120 (left-right image swap), U rows 110, B rows 120, etc. This makes it possible to suppress the occurrence of crosstalk even when the observer 90 moves, and enables a good, low-crosstalk stereoscopic image to be obtained across a wide zone.

[Two-Dimensional Display Mode]

In the two-dimensional display mode, the control unit 40 causes both the U rows 110 and the B rows 120 to be lit. At this time, the control unit 40 causes the same pixel data to be displayed in adjacent pixels 111 of the U rows 110. In the same manner, the control unit 40 causes the same pixel data to be displayed in adjacent pixels 121 of the B rows 120. In accordance with this, the right-eye image and the left-eye image become the same image. That is, the same image is presented to the right eye 90R and to the left eye 90L. In accordance with this, the observer 90 perceives the image displayed on the display panel 10 as a planar image.

In addition, the control unit 40 causes the same image to be displayed in adjacent U rows 110 and B rows 120 in the two-dimensional display mode. As was previously described, the light emitted from the U rows 110 and separated by the lens sheet 20 and the light emitted from the B rows 120 and separated by the lens sheet 20 are offset by half of the inter-viewpoint distance in the horizontal direction. Thus, a low-luminance zone of the U rows 110 becomes a high-luminance zone of the B rows 120. Therefore, in accordance with both the U rows 110 and the B rows 120 being lit, and, in addition, the same image being displayed in adjacent U rows 110 and B rows 120, a flat luminance distribution is obtained by the overlapping thereof. This makes it possible to obtain a two-dimensional image without the moire effect.

The operation of the stereoscopic display device 1 has been described above. The effects of the stereoscopic display device 1 will be described below by presenting an example of a specific configuration.

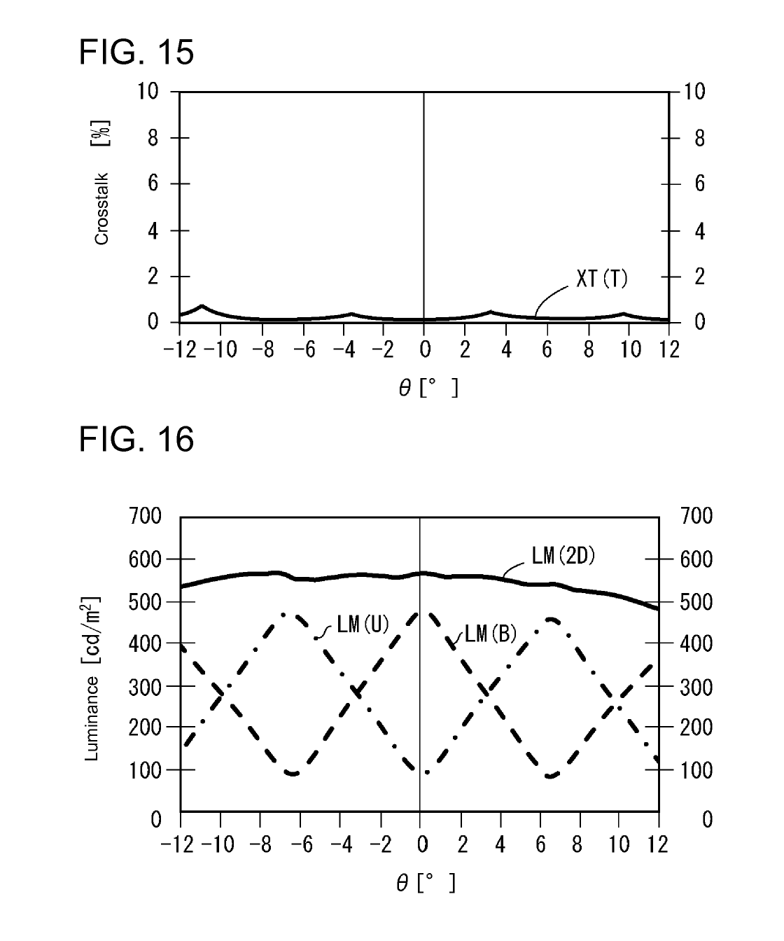

FIG. 14 and FIG. 15 are drawings illustrating the angular characteristics of crosstalk in the stereoscopic display device 1. This data was obtained using a stereoscopic display device 1 having a panel size of 3.5 inches, a pixel pitch p equal to 96 μm, a lens pitch P equal to 191.82 μm, a radius of curvature equal to 154 μm, and a lens shift s equal to 38 μm.

In FIG. 14, XT(U) is the angular characteristics of crosstalk when only the U rows 110 have been lit, and XT(B) is the angular characteristics of crosstalk when only the B rows 120 have been lit. As illustrated in FIG. 14, XT(U) and XT(B) have shapes that are offset by a half period.

As previously described, in the three-dimensional tracking display mode, the control unit 40 causes whichever is the low-crosstalk side in accordance with the position of the observer 90, i.e. the U rows 110 or the B rows 120, to be lit. Therefore, the angular characteristics of crosstalk XT(T) in the three-dimensional tracking display mode are as illustrated in FIG. 15. In the three-dimensional tracking display mode, it is possible to achieve low crosstalk across a wide zone as illustrated in FIG. 15.

The stereoscopic display device 1 performs tracking by switching the display images on the display panel 10. Thus, the stereoscopic display device 1 is able to perform tracking faster than a divided barrier technique, which will be described later.

In the stereoscopic display device 1 according to this embodiment, the low-crosstalk zone of the U rows 110 and the low-crosstalk zone of the B rows 120 both become wider in accordance with the effects of the double-arcuated cylindrical lenses 21 that have two lens centers 21a and 21b. A low-crosstalk state can be set across an entire range of angles by combining the double-arcuated cylindrical lenses 21 with tracking. It is preferable that the stereoscopic display device 1 be provided with double-arcuated cylindrical lenses 21 in this manner. However, the stereoscopic display device 1 may be provided with cylindrical lenses having a single lens center instead of the double-arcuated cylindrical lenses 21.

FIG. 16 is a drawing illustrating the angular characteristics of luminance in the same stereoscopic display device 1. In FIG. 16, LM(U) indicates the luminance angular characteristics when only the U rows 110 have been lit, LM(B) indicates the luminance angular characteristics when only the B rows 120 have been lit, and LM(2D) indicates the luminance angular characteristics when both the U rows 110 and the B rows 120 have been lit, respectively.

As illustrated in FIG. 16, LM(U) and LM(B) have shapes that are offset by a half period. Since these shapes are superimposed in the case of LM(2D) in which both the U rows 110 and the B rows 120 have been lit, flat angular characteristics are obtained. This enables a two-dimensional image without a moire effect to be obtained in the two-dimensional display mode.

Even in the three-dimensional display mode (either the U rows 110 or B rows 120 are lit), 80% of the luminance in the two-dimensional display mode can be obtained in accordance with the effect of the double-arcuated cylindrical lenses 21.

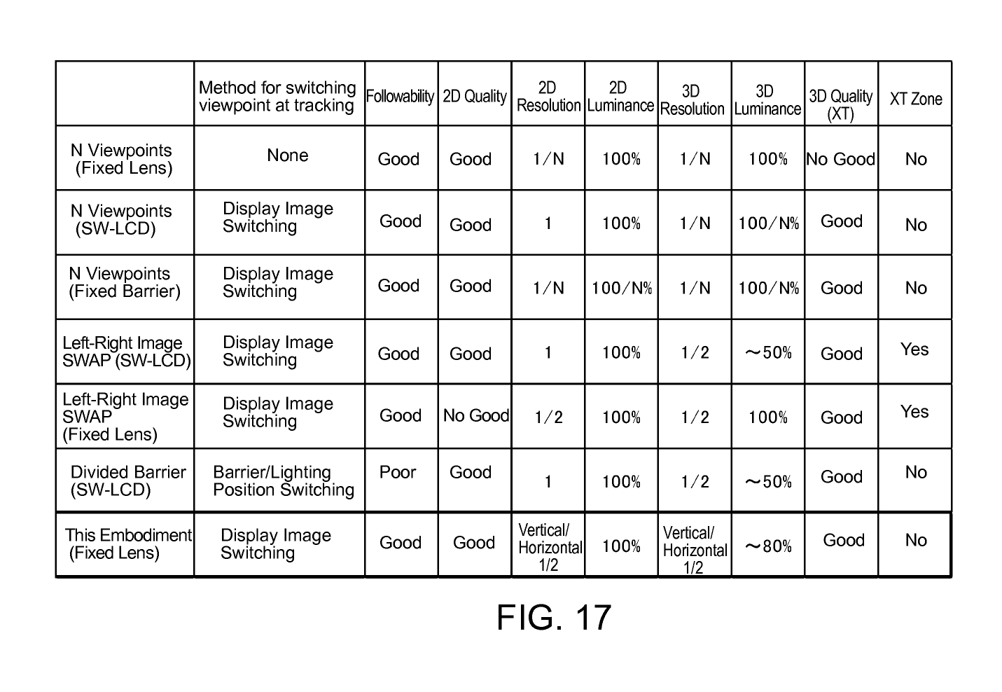

FIG. 17 is a table showing the characteristics of the stereoscopic display device 1 according to this embodiment in comparison with stereoscopic display devices based on other techniques. A “Followability” column records whether tracking response time is adequate. A “2D Quality” column records the image quality in the two-dimensional display mode. A “2D Resolution” column records what fraction of the display panel resolution is achieved in the two-dimensional display mode. A “2D Luminance” column records what percentage of the display panel luminance is achieved in the two-dimensional display mode. A “3D Resolution” column records what fraction of the display panel resolution is achieved in the three-dimensional display mode. A “3D Luminance” column records what percentage of the display panel 10 luminance is achieved in the three-dimensional display mode. A “3D Quality (XT)” column records the image quality in the three-dimensional display mode. An “XT Zone” column records the presence or absence of a high-crosstalk zone.

An “N Viewpoints (Fixed Lens)” technique is one that interpolates between two viewpoints by setting multiple viewpoints. Resolution is 1/N in both the two-dimensional display mode and the three-dimensional display mode. Furthermore, image quality is poor in the three-dimensional display mode.

An “N Viewpoints (SW-LCD)” technique and an “N Viewpoints (Fixed Barrier)” technique are techniques that separate an image into N viewpoints using a barrier. In these techniques, in addition to resolution being 1/N, luminance becomes 100/N % due to the barrier. The “N Viewpoints (SW-LCD)” technique switches between the two-dimensional display mode and the three-dimensional display mode using a switched liquid crystal display panel. Thus, luminance and resolution of 100% are possible in the two-dimensional display mode. However, luminance and resolution remain at 1/N when in the three-dimensional display mode.

A “Left-Right Image SWAP (SW-LCD)” technique and a “Left-Right Image SWAP (Fixed Lens)” technique are techniques that switch between the right-eye image and the left-eye image by tracking the position of the observer. These techniques make it possible to avoid reversed stereo. However, there will always be a high-crosstalk zone. Furthermore, since the “Left-Right Image SWAP (SW-LCD)” technique separates an image using a barrier, the resolution in the three-dimensional display mode is ½. Since the “Left-Right Image SWAP (Fixed Lens)” technique continues to separate the image in the two-dimensional display mode as well, the moire effect occurs. Thus, image quality in the two-dimensional display mode is poor.

A “Divided Barrier (SW-LCD)” technique is a technique that closely controls the liquid crystal molecules of a switched liquid crystal display panel to change the position of the barrier in accordance with the position of the observer. This makes it possible to eliminate a high-crosstalk zone. However, since the position of the barrier is changed by driving the liquid crystal molecules, the response time is not adequate. Furthermore, since the image is separated using a barrier, the luminance in the three-dimensional display mode is ½.

According to this embodiment, it is possible to reduce crosstalk across a wide zone in the three-dimensional tracking display mode. Tracking response time is also adequate. A two-dimensional image with little moire effect can be obtained in the two-dimensional display mode. In addition, luminance equivalent to 80% of the luminance of the display panel 10 can be obtained even in the three-dimensional display mode.

It is preferable that the stereoscopic display device 1 be designed such that the right-eye image and the left-eye image emitted from the U rows 110 and separated by the lens sheet 20 be respectively offset by half of the inter-viewpoint distance from the right-eye image and the left-eye image emitted from the B rows 120 and separated by the lens sheet 20 as in this embodiment. That is, it is preferable that the stereoscopic display device 1 be designed such that the LM(U) and the LM(B) are offset by a half period as illustrated in FIG. 16. However, a fixed effect can be obtained when the positions of the right-eye image and the left-eye image emitted from the U rows 110 and separated by the lens sheet 20 differ in the horizontal direction from the positions of the right-eye image and the left-eye image emitted from the B rows 120 and separated by the lens sheet 20.

### Embodiment 2

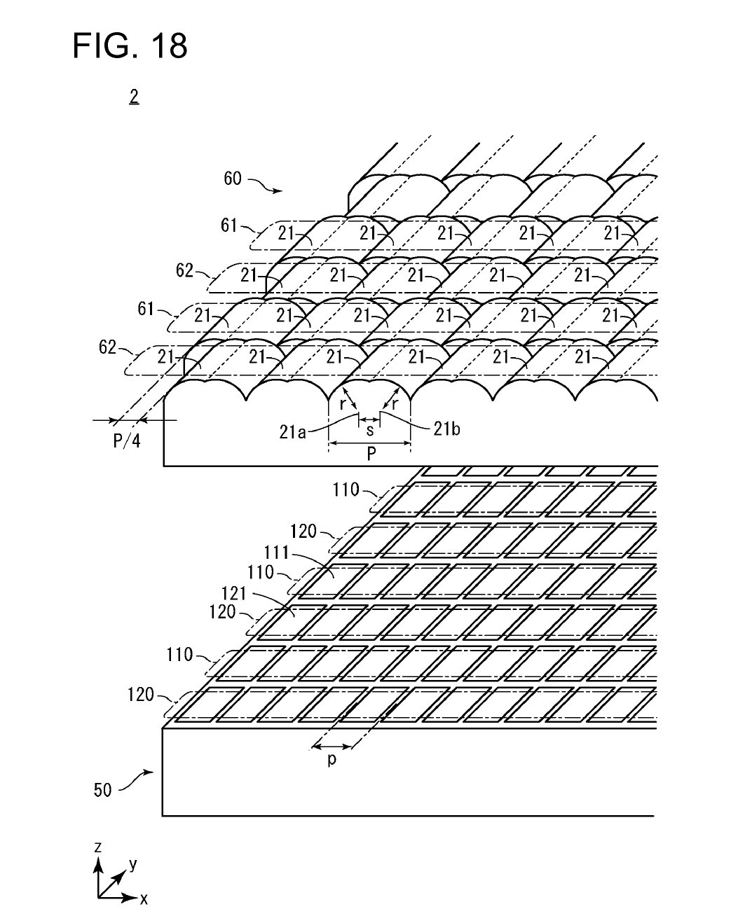

A stereoscopic display device 2 according to an Embodiment 2 of the present invention is provided with a display panel 50 in place of the display panel 10 of the stereoscopic display device 1. The stereoscopic display device 2 is further provided with a lens sheet 60 in place of the lens sheet 20 of the stereoscopic display device 1. FIG. 18 is an exploded perspective view illustrating the configuration of the lens sheet 60, and the arrangement of the pixels in the display panel 50 in detail.

The arrangement of the pixels in the display panel 50 differs from that of the display panel 10. In the display panel 50, the positions of the pixels 111 in the U rows 110 and the pixels 121 in the B rows 120 are lined up in the horizontal direction. That is, the pixel arrangement of the display panel 50 is a matrix pixel arrangement.

The lens sheet 60 includes first lens rows 61 superimposed on the U rows 110 in the plan view, and second lens rows 62 superimposed on the B rows 120 in the plan view. That is, the light emitted from the U rows 110 is separated by the first lens rows 61, and the light emitted from the B rows 120 is separated by the second lens rows 62. Each of the first lens rows 61 and the second lens rows 62 includes a plurality of cylindrical lenses 21 aligned at a prescribed lens pitch P in the horizontal direction.

The first lens rows 61 and the second lens rows 62 are arranged so as to be offset by ¼ of the lens pitch P in the horizontal direction. In accordance with this, the positions of the right-eye image and the left-eye image emitted from the U rows 110 and separated by the lens sheet 60 differ in the horizontal direction from the positions of the right-eye image and the left-eye image emitted from the B rows 120 and separated by the lens sheet 60.

More specifically, these images are offset by half of the inter-viewpoint distance in the horizontal direction in the same manner as in the Embodiment 1. In this embodiment as well, either the U rows 110 or the B rows 120 are lit in accordance with the position of the observer 90 in the three-dimensional tracking display mode. This makes it possible to reduce crosstalk across a wide zone.

The arrangement of the pixels in the display panel 50 of the stereoscopic display device 2 is an often used matrix pixel arrangement. Therefore, mass productivity is superior to that of the display panel 10 of the stereoscopic display device 1.

### Embodiment 3

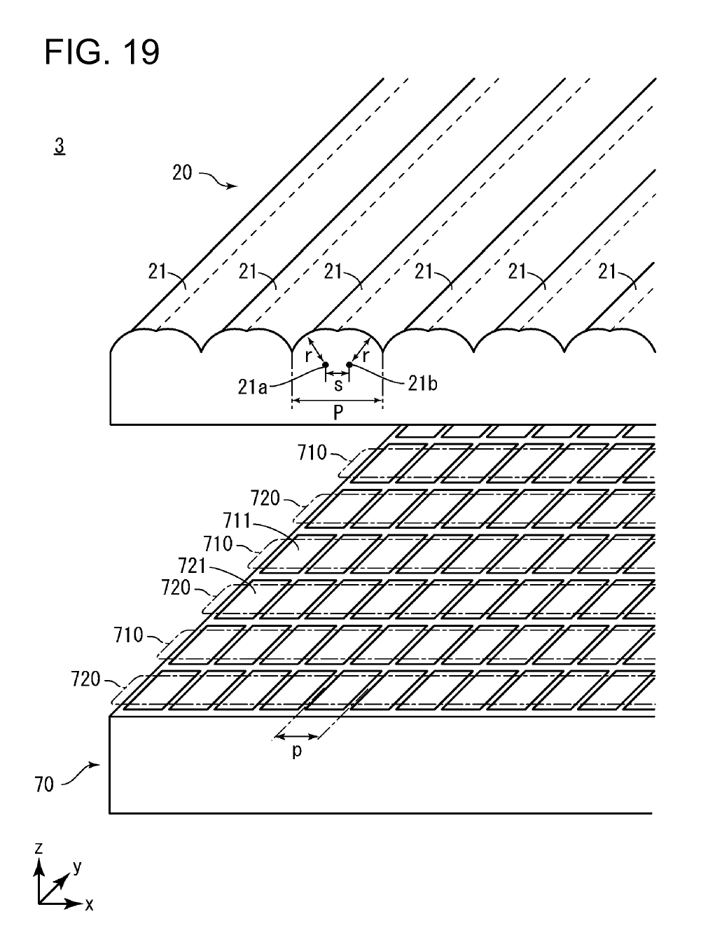

A stereoscopic display device 3 according to an Embodiment 3 of the present invention is provided with a display panel 70 in place of the display panel 10 of the stereoscopic display device 1. FIG. 19 is an exploded perspective view illustrating the lens sheet 20 and the pixel arrangement of the display panel 70.

The display panel 70 includes U rows 710 in place of the U rows 110 of the display panel 10, and includes B rows 720 in place of the B rows 120 of the display panel 10. The U rows 710 include a plurality of pixels 711 aligned at the pixel pitch p in the horizontal direction. In the same manner, the B rows 720 include a plurality of pixels 721 aligned at the pixel pitch p in the horizontal direction.

The positions of pixels 711 of the U rows 710 and pixels 721 of the B rows 720 are lined up in the horizontal direction. That is, the pixel arrangement of the display panel 50 is a matrix pixel arrangement.

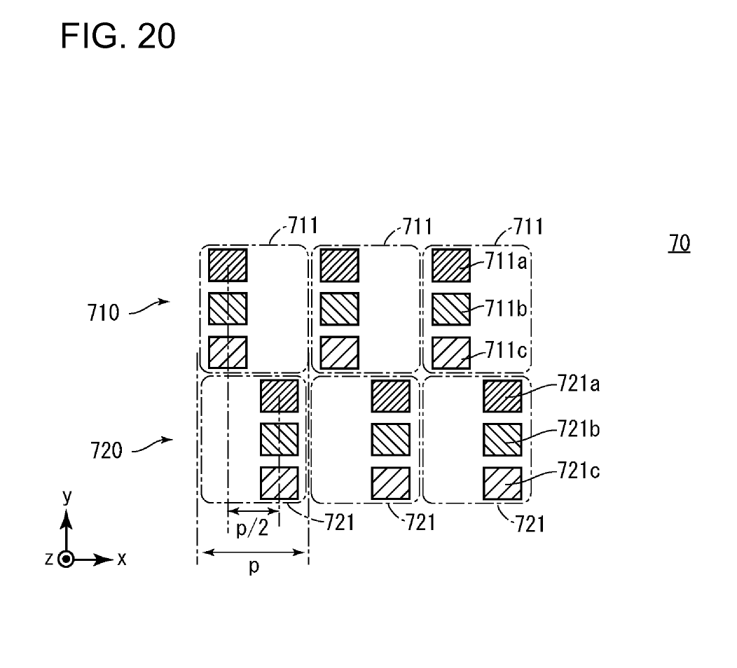

FIG. 20 is a plan view illustrating the configurations of the pixels 711 and the pixels 721 in detail. The pixels 711 include sub-pixels 711a, 711b, and 711c, which are aligned in the vertical direction. In the same manner, the pixels 721 include sub-pixels 721a, 721b, and 721c, which are aligned in the vertical direction. The hatching in FIG. 20 schematically represents the fact that the respective sub-pixels are different colors, and does not indicate a cross-sectional structure.

The sub-pixels 711a and 721b transmit red light, the sub-pixels 711b and 721b transmit green light, and the sub-pixels 711c and 721c transmit blue light, for example. In areas other than these, the light is shielded by a black matrix. In other words, the pixels 711 have light transmissive portions in the sub-pixels 711a, 711b, and 711c, and the pixels 721 have light transmissive portions in the sub-pixels 721a, 721b, and 721c.

The sub-pixels 711a, 711b, and 711c, and the sub-pixels 721a, 721b, and 721c are arranged so as to be offset by half (p/2) of the pixel pitch p in the horizontal direction. That is, the light transmissive portions in the pixels 711 of the U rows 710 and the light transmissive portions in the pixels 721 of the B rows 720 are arranged so as to be offset by half (p/2) of the pixel pitch p in the horizontal direction. In accordance with this, the positions of the right-eye image and the left-eye image emitted from the U rows 710 and separated by the lens sheet 20 differ in the horizontal direction from the positions of the right-eye image and the left-eye image emitted from the B rows 720 and separated by the lens sheet 20.

More specifically, these images are offset by half of the inter-viewpoint distance in the horizontal direction in the same manner as the Embodiment 1. In this embodiment, too, either the U rows 710 or the B rows 720 are lit in accordance with the position of the observer 90 in the three-dimensional tracking display mode. This makes it possible to reduce crosstalk across a wide zone.

The arrangement of the pixels in the display panel 70 of the stereoscopic display device 3 is the often used matrix pixel arrangement, and only the configuration of the color filter need be changed. Therefore, mass productivity is superior to that of the display panel 10 of the stereoscopic display device 1.

### Other Embodiments

Embodiments of the present invention have been described above, but the present invention is not limited to the above-described embodiments alone, and various changes can be made without departing from the scope of the invention. The respective embodiments can be put into practice by combining them as appropriate.

In the embodiments described above, descriptions were given of examples in which liquid crystal display panels were used as the display panels. However, a plasma display panel, or an organic electroluminescent (EL) panel may be used in place of the liquid crystal display panel.

### INDUSTRIAL APPLICABILITY

The present invention can be applied industrially as a stereoscopic display device.

1. A stereoscopic display device, comprising:
a display panel for displaying image data;
a lens sheet superimposed on said display panel to receive the image data displayed on said display panel and form a right-eye image and a left-eye image that are separated in a horizontal direction adjacent to an observer;
a control unit that controls said display panel; and
a position sensor that acquires positional information of the observer and supplies said positional information to said control unit,
wherein said display panel includes a first set of pixel rows and a second set of pixel rows alternately arranged in a vertical direction,
wherein a position of said right-eye image originating from said first set of pixel rows and formed by said lens sheet differs in the horizontal direction from a position of said right-eye image originating from said second set of pixel rows and formed by said lens sheet,
wherein a position of said left-eye image originating from said first set of pixel rows and formed by said lens sheet differs in the horizontal direction from a position of said left-eye image originating from said second set of pixel rows and formed by said lens sheet, and
wherein said control unit, based on said positional information of the observer, selects either the first set or second set of pixel rows for display and causes pixel data that forms said right-eye image and pixel data that forms said left-eye image to be alternately displayed in the horizontal direction in the selected first or second set of pixel rows so that the observer can continue to see a stereoscopic image even when the observer moves relative to the stereoscopic display device.

2. The stereoscopic display device according to claim 1,
wherein said lens sheet includes a plurality of cylindrical lenses extending in the vertical direction, and
wherein each of said plurality of cylindrical lenses has two lens centers separated by a prescribed pitch in the horizontal direction.

3. The stereoscopic display device according to claim 1,
wherein each row of said first set of pixel rows and said second set of pixel rows includes a plurality of pixels aligned at a prescribed pixel pitch in the horizontal direction, and
wherein the pixels in the first set of pixel rows and the pixels of the second set of pixel rows are arranged so as to be offset by half of said pixel pitch in the horizontal direction.

4. The stereoscopic display device according to claim 1,
wherein said lens sheet includes a first set of lens rows superimposed on said first set of pixel rows in a plan view, and a second set of lens rows superimposed on said second set of pixel rows in the plan view,
wherein each row of said first set of lens rows and said second set of lens rows includes a plurality of lenses aligned at a prescribed lens pitch in the horizontal direction, and
wherein the lenses of said first set of lens rows and the lenses of said second set of lens rows are arranged so as to be offset by ¼ of said lens pitch in the horizontal direction.

5. The stereoscopic display device according to claim 1,
wherein each row of said first set of pixel rows and said second set of pixel rows includes a plurality of pixels aligned at a prescribed pixel pitch in the horizontal direction, and
wherein respective light transmissive portions in pixels of said first set of pixel rows and respective light transmissive portions in pixels of said second set of pixel rows are arranged so as to be offset by half of said pixel pitch in the horizontal direction.

6. The stereoscopic display device according to claim 1, wherein said control unit has a two-dimensional display mode as a display mode, and in said two-dimensional display mode, said control unit causes an image to be displayed in both said first set of pixel rows and said second set of pixel rows regardless of said positional information of the observer, and causes the same image to be displayed in adjacent said first set of pixel rows and said second set of pixel rows.

7. The stereoscopic display device according to claim 1, wherein said display panel is a liquid crystal display panel.

8. The stereoscopic display device according to claim 2,
wherein each row of said first set of pixel rows and said second set of pixel rows includes a plurality of pixels aligned at a prescribed pixel pitch in the horizontal direction, and
wherein the pixels in the first set of pixel rows and the pixels of the second set of pixel rows are arranged so as to be offset by half of said pixel pitch in the horizontal direction.

9. The stereoscopic display device according to claim 2,
wherein said lens sheet includes a first set of lens rows superimposed on said first set of pixel rows in a plan view, and a second set of lens rows superimposed on said second set of pixel rows in the plan view,
wherein each row of said first set of lens rows and said second set of lens rows includes a plurality of lenses aligned at a prescribed lens pitch in the horizontal direction, and
wherein the lenses of said first set of lens rows and the lenses of said second set of lens rows are arranged so as to be offset by ¼ of said lens pitch in the horizontal direction.

10. The stereoscopic display device according to claim 2,
wherein each row of said first set of pixel rows and said second set of pixel rows includes a plurality of pixels aligned at a prescribed pixel pitch in the horizontal direction, and
wherein respective light transmissive portions in pixels of said first set of pixel rows and respective light transmissive portions in pixels of said second set of pixel rows are arranged so as to be offset by half of said pixel pitch in the horizontal direction.
